(19) United States
(12) Patent Application Publication
(10) Pub. No.: US 2025/0230013 A1
(43) Pub. Date: Jul. 17, 2025

(54) ELEVATOR CALL ALLOCATION

(71) Applicant: KONE Corporation, Helsinki (FI)

(72) Inventors: Janne ÖFVERSTEN, Helsinki (FI); Ville PIIRAINEN, Helsinki (FI); Tommi LOUKAS, Helsinki (FI); Jussi-Pekka PARTANEN, Helsinki (FI); Jaakko RANNE, Helsinki (FI)

(73) Assignee: KONE Corporation, Helsinki (FI)

(21) Appl. No.: 19/171,592

(22) Filed: Apr. 7, 2025

Related U.S. Application Data
(63) Continuation of application No. PCT/EP2022/079761, filed on Oct. 25, 2022.

(51) Int. Cl. B66B 1/24

(52) U.S. Cl. CPC B66B 1/2458; B66B 2201/10; B66B 2201/40

(57) ABSTRACT

According to an aspect, there is provided a method for elevator call allocation in an elevator group comprising a plurality of elevator cars. The method comprises detecting a logistic operation associated with an elevator car, the elevator car being stationary at a floor, and limiting allocation of new elevator calls to the elevator car in the elevator group in response to detecting the logistic operation.

### BACKGROUND

Elevators in buildings can be used to transport passengers and various deliveries. Normally, a passenger may make a destination call, a floor call or a car call, and the passenger is transported to a selected destination floor. Sometimes elevators may be reserved for extended periods of time, and the duration may be unknown and difficult to accurately estimate, for example, when loading furniture or other large items to an elevator. This may mean that that some users, for example, on nearby floors, may have to wait a long time, since their calls may have been allocated to the same elevator that is momentarily unavailable to serve them.

### SUMMARY

According to a first aspect, there is provided a method for an elevator call allocation in an elevator group comprising a plurality of elevator cars. The method comprises detecting a logistic operation associated with an elevator car, the elevator car being stationary at a floor, and limiting allocation of new elevator calls to the elevator car in the elevator group in response to detecting the logistic operation.

In an implementation form of the first aspect, the method further comprises obtaining data relating to elevator door operation monitoring and/or elevator car position monitoring, and detecting the logistic operation associated with the elevator car at least partly based on the data.

In an implementation form of the first aspect, the method further comprises obtaining data relating to at least one usage pattern associated with the doors of the elevator car; and detecting the logistic operation associated with the elevator car at least partly based on the data.

In an implementation form of the first aspect, the at least one usage pattern comprises at least one of: a usage pattern associated with how long doors remain open, a usage pattern associated with close-reopen cycles of the doors, and a usage pattern associated with door opening buttons.

In an implementation form of the first aspect, the method further comprises detecting the logistic operation at least partly based on signaling transmitted in an elevator control system.

In an implementation form of the first aspect, the method further comprises detecting the logistic operation at least partly based on data associated with monitoring the elevator car and/or a lobby area associated with elevator car.

In an implementation form of the first aspect, the method further comprises detecting the logistic operation associated with the elevator car at least partly using a trained machine learning model, the trained machine learning model being trained at least partly based on local usage data associated with the elevator group.

In an implementation form of the first aspect, the method further detecting comprises the logistic operation associated with the elevator car at least partly using a trained machine learning model, the trained machine learning model being trained at least partly based on usage data associated with at least one other elevator group.

In an implementation form of the first aspect, the method further comprises detecting the logistic operation associated with the elevator car at least partly using a trained machine learning model, the trained machine learning model being trained at least partly based on at least one elevator door parameter associated loading calls.

In an implementation form of the first aspect, limiting allocation of new elevator calls to the elevator car in the elevator group in response to detecting the logistic operation comprises removing the elevator car from active elevator call allocation.

In an implementation form of the first aspect, limiting allocation of new elevator calls to the elevator car in the elevator group in response to detecting the logistic operation comprises adjusting an availability estimate associated with the elevator car.

In an implementation form of the first aspect, the method further comprises obtaining a prediction of an ending of the logistic operation, the prediction being based at least partly on monitoring the elevator car and/or lobby area associated with elevator car, and resuming allocating calls to the elevator car based on the prediction.

In an implementation form of the first aspect, the method further comprises detecting an ending of the logistic operation and resuming allocating calls to the elevator car.

According to a second aspect, there is provided a system comprising means for detecting a logistic operation associated with an elevator car, the elevator car being stationary at a floor, and means for limiting allocation of new elevator calls to the elevator car in the elevator group in response to detecting the logistic operation.

In an implementation form of the second aspect, the system further comprises means for obtaining data relating to elevator door operation monitoring and/or elevator car position monitoring, and means for detecting the logistic operation associated with the elevator car at least partly based on the data.

In an implementation form of the second aspect, the system further comprises means for obtaining data relating to at least one usage pattern associated with the doors of the elevator car, and means for detecting the logistic operation associated with the elevator car at least partly based on the data.

In an implementation form of the second aspect, the at least one usage pattern comprises at least one of: a usage pattern associated with how long doors remain open, a usage pattern associated with close-reopen cycles of the doors, and a usage pattern associated with door opening buttons.

In an implementation form of the second aspect, the system further comprises means for detecting the logistic operation at least partly based on signaling transmitted in an elevator control system.

In an implementation form of the second aspect, the system further comprises means for detecting the logistic operation at least partly based on data associated with monitoring the elevator car and/or a lobby area associated with elevator car.

In an implementation form of the second aspect, the system further comprises means for detecting the logistic operation associated with the elevator car at least partly using a trained machine learning model, the trained machine learning model being trained at least partly based on local usage data associated with the elevator group.

In an implementation form of the second aspect, the system further comprises means for detecting the logistic operation associated with the elevator car at least partly using a trained machine learning model, the trained machine learning model being trained at least partly based on usage data associated with at least one other elevator group.

In an implementation form of the second aspect, the system further comprises means for detecting the logistic operation associated with the elevator car at least partly using a trained machine learning model, the trained machine learning model being trained at least partly based on at least one elevator door parameter associated loading calls.

In an implementation form of the second aspect, the means for limiting allocation of new elevator calls to the elevator car in the elevator group in response to detecting the logistic operation are configured to remove the elevator car from active elevator call allocation.

In an implementation form of the second aspect, the means for limiting allocation of new elevator calls to the elevator car in the elevator group in response to detecting the logistic operation are configured to adjust an availability estimate associated with the elevator car.

In an implementation form of the second aspect, the system further comprises means for obtaining a prediction of an ending of the logistic operation, the prediction being based at least partly on monitoring the elevator car and/or lobby area associated with elevator car, and means for resuming allocating calls to the elevator car based on the prediction.

In an implementation form of the second aspect, the system further comprises means for detecting an ending of the logistic operation and means for resuming allocating calls to the elevator car.

According to a third aspect, there is provided a computer program comprising instructions for causing an apparatus to carry out the method of the first aspect.

According to a fourth aspect, there is provided a computer readable medium comprising a computer program comprising instructions for causing an apparatus to carry out the method of the first aspect.

According to a fifth aspect, there is provided an apparatus for construction time use of at least one elevator car of an elevator system in a building comprises a plurality of floors. The apparatus comprises at least one processor, and at least one memory storing instructions, that when executed by the at least one processor, cause the apparatus to perform: detecting a logistic operation associated with an elevator car, the elevator car being stationary at a floor, and limiting allocation of new elevator calls to the elevator car in the elevator group in response to detecting the logistic operation.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 illustrates an example of an elevator system according to an example embodiment.

FIG. 2 illustrates an example of a method according to an example embodiment.

FIG. 3 illustrates a block diagram of a system according to an example embodiment.

### DETAILED DESCRIPTION

Various examples and embodiments discussed herein disclose a solution for elevator call allocation in an elevator group comprising a plurality of elevator cars. A logistic operation associated with an elevator car may be detected, the elevator car being stationary at a floor. The term “logistic operation” used herein may refer to an operation or event involving, for example, people moving, large deliveries, or construction time use of elevators, wherein the event may reserve an elevator for an extended period of time whose duration may be unknown and difficult to estimate accurately, and thus the event may be time consuming. In an example embodiment, there may be a predefined time limit after which the event may be regarded as “time consuming” or labelled as a “logistic process”. In response to detecting the logistic operation, allocation of new elevator calls to the elevator car in the elevator group may be limited.

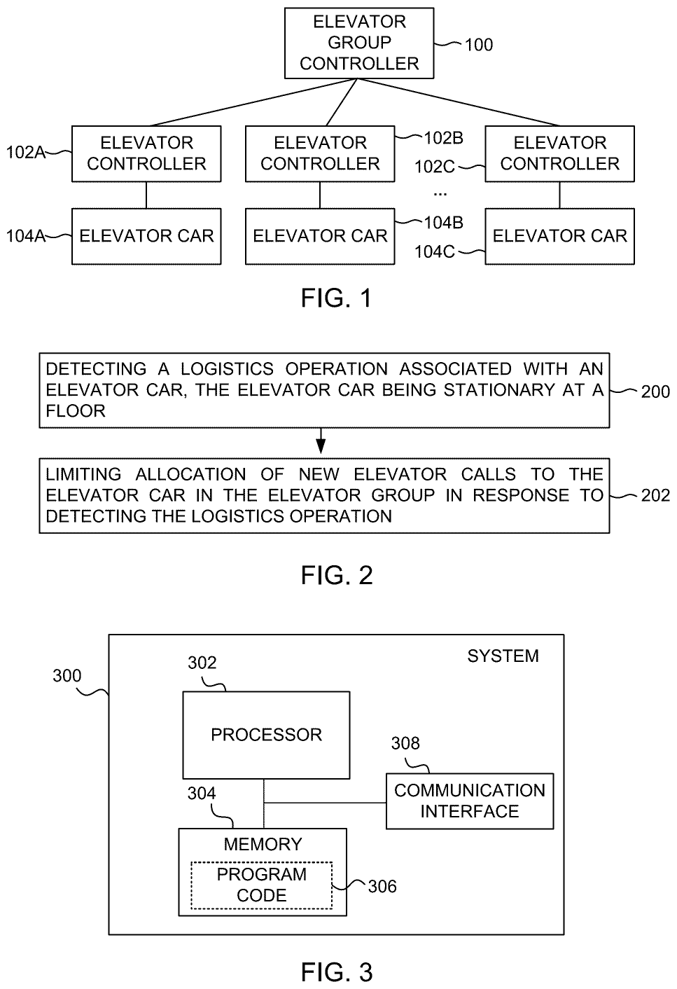

FIG. 1 illustrates an example of an elevator system according to an example embodiment. The elevator system comprises an elevator group controller 100 connected to elevator controllers 102A, 102B, 102C. Each elevator controller 102A, 102B, 102C controls its corresponding elevator car 104A, 104B, 104C. The elevator group controller 100 may be configured to allocate calls to the elevator cars 104A, 104B, 104C. In an example embodiment, the elevator group controller 100 may be configured to implement the functionality discussed below in various example embodiments. In another example embodiment, the functionality may be implemented partly by the elevator group controller 100 and partly by at least one device or entity connected to the elevator group controller 100.

FIG. 2 illustrates an example of a method for elevator call allocation in an elevator group comprising a plurality of elevator cars.

At 200 a logistic operation associated with an elevator car may be detected, the elevator car being stationary at a floor. The term “logistic operation” may refer to an event involving, for example, people moving, large deliveries, or construction time use of elevators, wherein the event may reserve an elevator for an extended period of time whose duration may be unknown and difficult to estimate accurately. The detection may be based, for example, on information provided by the elevator system itself and/or information that the elevator system obtains from an external device or system.

At 202 allocation of new elevator calls to the elevator car in the elevator group may be limited in response to detecting the logistic operation.

In an example embodiment, data relating to elevator door operation monitoring and/or elevator car position monitoring may be obtained, and the logistic operation associated with the elevator car may be detected at least partly based on the data. An elevator controller associated with the elevator car or an external device may monitor the elevator doors and/or the position of the elevator car, and the elevator controller may transmit data about the monitoring to an elevator group controller. For example, the elevator car may have been stationary for a first predetermined time limit and its door may been open for a second predetermined time limit. This may be used as a trigger for detecting the logistic operation.

In an example embodiment, data relating to at least one usage pattern associated with the doors of the elevator car may be obtained, and the logistic operation associated with the elevator car may be detected at least partly based on the data. The term “usage pattern” may refer to any pattern relating to one or more entities associated with the elevator car, for example, how long the elevator doors have remained open, close-reopen cycles of the elevator doors, usage of elevator door opening buttons etc. When a logistic operation usage pattern is detected, a call allocation in the elevator group can be changed so that an elevator call allocation engine run, for example, by the elevator group controller, does not allocate calls to an elevator that is already reserved for an unforeseeably long time.

In an example embodiment, the logistic operation may be detected at least partly based on signaling transmitted in an elevator control system. For example, protocol signaling or other messages used in the elevator control system may comprise information based on which the logistic operation can be detected. When the logistic operation is detected, the information may relayed to an elevator call allocation engine in the elevator group controller that manages the allocation of elevator cars to elevator calls. The elevator group controller may, for example, drop the unavailable elevator from active allocation until the exceptional situation has ended, or adjust an availability estimate of the elevator car in the elevator call allocation algorithm.

In an example embodiment, the logistic operation may be detected at least partly based on data associated with monitoring the elevator car and/or a lobby area associated with elevator car. For example, at least one device external to the elevator system, for example, at least one camera of a surveillance system, may provide information based on which a prediction of when the logistic operation is going to end, may be performed. An entity determining the prediction based on the data from the at least one device external to the elevator system may then relay the prediction to the elevator group controller so that elevator call allocations can be planned accordingly.

In an example embodiment, the logistic operation associated with the elevator car may be detected at least partly using a trained machine learning model, the trained machine learning model being trained at least partly based on local usage data associated with the elevator group. The local usage data may provide data from the same building on operations when a logistic operation has been detected and what indicators pointing towards the logistic operation were recorded for the logistic operation. For example, the elevator doors may have been open long, elevator door opening buttons were repeatedly used etc. This data can then be used to train the machine learning model.

In an example embodiment, the logistic operation associated with the elevator car at least partly using a trained machine learning model, the trained machine learning model being trained at least partly based on usage data associated with at least one other elevator group. The other elevator group may be an elevator group residing in a different building, in a different city or even in a different country etc. Certain characteristics of an identified logistic operation may apply similarly between different elevator groups, and this data can then be used to train the machine learning model.

In an example embodiment, the logistic operation associated with the elevator car may be detected at least partly using a trained machine learning model, the trained machine learning model being trained at least partly based on at least one elevator door parameter associated with loading calls. Some elevators or elevator systems may provide the possibility of indicating a special loading call when making the elevator call. The operation of, for example, a door operator and door open times may be recorded, when a loading call has been received, and this information can then be used to train the machine learning model that can then identify a loading situation even if cases when explicit loading calls have not been received.

In an example embodiment, limiting allocation of new elevator calls to the elevator car in the elevator group in response to detecting the logistic operation may comprise removing the elevator car from active elevator call allocation or adjusting an availability estimate associated with the elevator car. This may provide an advantage that an elevator call is not allocated to an elevator car that probably cannot serve the call in a reasonable time.

In an example embodiment, a prediction of an ending of the logistic operation may be obtained, the prediction being based at least partly on monitoring the elevator car and/or lobby area associated with elevator car, and allocating call to the elevator car may be resumed based on the prediction. For example, an external device, for example, a surveillance camera, may monitor the elevator car and/or a lobby area associated with the elevator car, and a prediction of when the logistic operation is going to end may be provided based on data provided by the external device. The prediction may be performed by some device of the elevator system or by a device external to the elevator system. The device can transmit the prediction to the elevator group controller so that elevator call allocations can be planned accordingly.

In an example embodiment, an ending of the logistic operation may be detected and allocating calls to the elevator car may be resumed. The detection may be performed, for example, when detecting that the elevator doors of the elevator car have been closed. In another example embodiment, it may be detected that both loading at a source floor and unloading at a destination floor have been performed, and in response to this, allocating calls to the elevator car may be resumed. In another example embodiment, a timer setting a predefined time (for example, 1-5 minutes or any appropriate timer value) may be used, and the detection may be performed when the timer expires. In an example embodiment, the value of the timer may depend on the items, for example, the type, weight and/or amount of items, being transported with the elevator cars.

FIG. 3 illustrates a block diagram of a system 300 according to an example embodiment. The system 300 may comprise, for example, a controller, a computer or a group of controllers, computers or other system entities configured to implement the above discussed features. In an example embodiment, the system 300 may be integrated to be part of an elevator controller, an elevator group controller or an elevator drive as a separate circuit board/module or as an integrated hardware. In another example embodiment, the system 300 may be implemented, for example, with an additional software module in the elevator controller, elevator group controller or elevator drive. In other words, the system 300 may refer, for example, to an elevator controller, an elevator group controller or an elevator drive that is configured to implement the above discussed features. The system 300 may be configured to detect a logistic operation associated with an elevator car, the elevator car being stationary at a floor, and limit allocation of new elevator calls to the elevator car in the elevator group in response to detecting the logistic operation.

The system 300 may comprise one or more processors 302, and one or more memories 304 that comprise computer program code. The system 300 may also include at least one communication interface 308 configured to provide wireless and/or wired connectivity. Although the system 300 is depicted to include only one processor 302, the system 300 may include more than one processor. In an example embodiment, the memory 304 is capable of storing instructions, such as an operating system and/or various applications.

Furthermore, the processor 302 is capable of executing the stored instructions. In an example embodiment, the processor 302 may be embodied as a multi-core processor, a single core processor, or a combination of one or more multi-core processors and one or more single core processors. For example, the processor 302 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an example embodiment, the processor 302 may be configured to execute hard-coded functionality. In an example embodiment, the processor 302 is embodied as an executor of software instructions, wherein the instructions may specifically configure the processor 302 to perform the algorithms and/or operations described herein when the instructions are executed.

The memory 304 may be embodied as one or more volatile memory devices, one or more non-volatile memory devices, and/or a combination of one or more volatile memory devices and non-volatile memory devices. For example, the memory 304 may be embodied as semiconductor memories (such as mask ROM, PROM (programmable ROM), EPROM (erasable PROM), flash ROM, RAM (random access memory), etc.).

In an embodiment, the at least one memory 304 may store program instructions 306 that, when executed by the at least one processor 302, cause the system 300 to perform the functionality of the various embodiments discussed herein. Further, in an embodiment, at least one of the processor 302 and the memory 304 may constitute means for implementing the discussed functionality.

One or more of the examples and example embodiments discussed above may enable a solution that reduces waiting times on nearby landing as no new elevator calls are allocated to an elevator for which a logistic operation has been detected.

Example embodiments may be implemented in software, hardware, application logic or a combination of software, hardware and application logic. The example embodiments can store information relating to various methods described herein. This information can be stored in one or more memories, such as a hard disk, optical disk, magneto-optical disk, RAM, and the like. One or more databases can store the information used to implement the example embodiments. The databases can be organized using data structures (e.g., records, tables, arrays, fields, graphs, trees, lists, and the like) included in one or more memories or storage devices listed herein. The methods described with respect to the example embodiments can include appropriate data structures for storing data collected and/or generated by the methods of the devices and subsystems of the example embodiments in one or more databases.

The components of the example embodiments may include computer readable medium or memories for holding instructions programmed according to the teachings and for holding data structures, tables, records, and/or other data described herein. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer. A computer-readable medium may include a computer-readable storage medium that may be any media or means that can contain or store the instructions for use by or in connection with an instruction execution system, apparatus, or device, such as a computer. A computer readable medium can include any suitable medium that participates in providing instructions to a processor for execution. Such a medium can take many forms, including but not limited to, non-volatile media, volatile media, transmission media, and the like.

While there have been shown and described and pointed out fundamental novel features as applied to preferred embodiments thereof, it will be understood that various omissions and substitutions and changes in the form and details of the devices and methods described may be made by those skilled in the art without departing from the spirit of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or embodiments may be incorporated in any other disclosed or described or suggested form or embodiment as a general matter of design choice. Furthermore, means-plus-function clauses are intended to cover the structures described herein as performing the recited function and not only structural equivalents, but also equivalent structures.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications May be made within the scope of the disclosure.

1. A method for elevator call allocation in an elevator group comprising a plurality of elevator cars, the method comprising:
detecting a logistic operation associated with an elevator car, the elevator car being stationary at a floor; and
limiting allocation of new elevator calls to the elevator car in the elevator group in response to detecting the logistic operation.

2. The method of claim 1, further comprising:
obtaining data relating to elevator door operation monitoring and/or elevator car position monitoring; and
detecting the logistic operation associated with the elevator car at least partly based on the data.

3. The method of claim 1, further comprising:
obtaining data relating to at least one usage pattern associated with the doors of the elevator car; and
detecting the logistic operation associated with the elevator car at least partly based on the data.

4. The method of claim 3, wherein the at least one usage pattern comprises at least one of:
a usage pattern associated with how long doors remain open;
a usage pattern associated with close-reopen cycles of the doors; and
a usage pattern associated with door opening buttons.

5. The method of claim 1, further comprising:
detecting the logistic operation at least partly based on signaling transmitted in an elevator control system.

6. The method of claim 1, further comprising:
detecting the logistic operation at least partly based on data associated with monitoring the elevator car and/or a lobby area associated with elevator car.

7. The method of claim 1, further comprising:
detecting the logistic operation associated with the elevator car at least partly using a trained machine learning model, the trained machine learning model being trained at least partly based on local usage data associated with the elevator group.

8. The method of claim 1, further comprising:
detecting the logistic operation associated with the elevator car at least partly using a trained machine learning model, the trained machine learning model being trained at least partly based on usage data associated with at least one other elevator group.

9. The method of claim 1, further comprising:
detecting the logistic operation associated with the elevator car at least partly using a trained machine learning model, the trained machine learning model being trained at least partly based on at least one elevator door parameter associated loading calls.

10. The method of claim 1, wherein limiting allocation of new elevator calls to the elevator car in the elevator group in response to detecting the logistic operation comprises:
removing the elevator car from active elevator call allocation.

11. The method of claim 1, wherein limiting allocation of new elevator calls to the elevator car in the elevator group in response to detecting the logistic operation comprises:
adjusting an availability estimate associated with the elevator car.

12. The method of claim 1, further comprising:
obtaining a prediction of an ending of the logistic operation, the prediction being based at least partly on monitoring the elevator car and/or lobby area associated with elevator car; and
resuming allocating calls to the elevator car based on the prediction.

13. The method of claim 1, further comprising:
detecting an ending of the logistic operation; and
resuming allocating calls to the elevator car.

14. A system comprising:
means for detecting a logistic operation associated with an elevator car, the elevator car being stationary at a floor; and
means for limiting allocation of new elevator calls to the elevator car in the elevator group in response to detecting the logistic operation.

15. The system of claim 14, further comprising:
means for obtaining data relating to elevator door operation monitoring and/or elevator car position monitoring; and
means for detecting the logistic operation associated with the elevator car at least partly based on the data.

16. The system of claim 14, further comprising:
means for obtaining data relating to at least one usage pattern associated with the doors of the elevator car; and
means for detecting the logistic operation associated with the elevator car at least partly based on the data.

17. The system of claim 16, wherein the at least one usage pattern comprises at least one of:
a usage pattern associated with how long doors remain open;
a usage pattern associated with close-reopen cycles of the doors; and
a usage pattern associated with door opening buttons.

18. The system of claim 14, further comprising:
means for detecting the logistic operation at least partly based on signaling transmitted in an elevator control system.

19. The system of claim 14, further comprising:
means for detecting the logistic operation at least partly based on data associated with monitoring the elevator car and/or a lobby area associated with elevator car.

20. The system of claim 14, further comprising:
means for detecting the logistic operation associated with the elevator car at least partly using a trained machine learning model, the trained machine learning model being trained at least partly based on local usage data associated with the elevator group.

21. The system of claim 14, further comprising:
means for detecting the logistic operation associated with the elevator car at least partly using a trained machine learning model, the trained machine learning model being trained at least partly based on usage data associated with at least one other elevator group.

22. The system of claim 14, further comprising:
means for detecting the logistic operation associated with the elevator car at least partly using a trained machine learning model, the trained machine learning model being trained at least partly based on at least one elevator door parameter associated loading calls.

23. The system of claim 14, wherein the means for limiting allocation of new elevator calls to the elevator car in the elevator group in response to detecting the logistic operation are configured to remove the elevator car from active elevator call allocation.

24. The system of claim 14, wherein the means for limiting allocation of new elevator calls to the elevator car in the elevator group in response to detecting the logistic operation are configured to adjust an availability estimate associated with the elevator car.

25. The system of claim 14, further comprising:
means for obtaining a prediction of an ending of the logistic operation, the prediction being based at least partly on monitoring the elevator car and/or lobby area associated with elevator car; and
means for resuming allocating calls to the elevator car based on the prediction.

26. The system of claim 14, further comprising:
means for detecting an ending of the logistic operation; and
means for resuming allocating calls to the elevator car.

27. A non-transitory computer readable medium storing a computer program comprising instructions for causing an apparatus to carry out the method of claim 1.

28. A non-transitory computer readable medium comprising a computer program comprising instructions for causing an apparatus to carry out the method of claim 2.
